(19) United States
(12) Patent Application Publication
(10) Pub. No.: US 2012/0103652 A1
(43) Pub. Date: May 3, 2012

(54) SHIELDED ELECTRIC WIRE

(75) Inventors: Yurie Ooyama, Shizuoka (JP); Hiroyuki Ogura, Shizuoka (JP); Daisuke Yagi, Shizuoka (JP)

(73) Assignee: YAZAKI CORPORATION, Tokyo (JP)

(21) Appl. No.: 13/381,724

(22) PCT Filed: Jun. 8, 2010
(86) PCT No.: PCT/JP2010/059724

§ 371 Date: Dec. 30, 2011

(30) Foreign Application Priority Data
Jul. 2, 2009 (JP) 2009-157871

(51) Int. Cl. H01B 9/02

(52) U.S. Cl. 174/105 R

(57) ABSTRACT

The object of the present invention is to provide a shielded electric wire, wherein variation in induction characteristics of respective insulation-coated conductive wires is eliminated, excellent induction-resistance characteristics are achieved, a weight and costs are reduced by reducing a use amount of a drain wire, and a step of providing a drain wire longitudinally is simplified. In the shielded electric wire 11 covering the periphery of the plurality of insulation-coated conductive wires 3a to 3d and the drain wire 13 with the external conductor 15, the drain wire 13 is provided longitudinally and straight along one side of the conductive wire bundle of the plurality of twisted insulation-coated conductive wires 3a to 3d, such that twist or closeness of the respective insulation-coated conductive wires 3a to 3d with respect to the drain wire 13 is equalized.

### TECHNICAL FIELD

The present invention is related to a shielded electric wire including a plurality of insulation-coated conductive wires, a drain wire provided along a length of the insulation-coated conductive wires and grounded at ends of the insulation-coated conductive wires, an external conductor forming a shielding layer covering a periphery of the insulation-coated conductive wires and the drain wire, and an insulation material layer covering an outer circumference of the external conductor.

### BACKGROUND ART

FIG. 2 is a horizontal cross-sectional view of a shielded electric wire.

The shielded electric wire 1 is a shielded electric wire having four cores and includes four insulation-coated conductive wires 3a to 3d, a drain wire 6 provided along a length of the insulation-coated conductive electric wires 3a to 3d and grounded at the ends of the insulation-coated conductive wires 3a to 3d, an external conductor 7 forming a shielding layer covering a periphery of the insulation-coated conductive wires 3a to 3d and the drain wire 6, and an insulation material layer 9 covering an outer circumference of the external conductor 7.

The insulation-coated conductive wires 3a to 3d have a structure in which periphery of a conductor 4 used for transmission of a signal is covered with an insulation sheath 5. The drain wire 6 is a naked conductor having no insulation sheath.

The external conductor 7 is formed by laminating a metallic foil layer on one side surface of an insulation film 8, and wrapped around the outer circumference of the four insulation-coated conductive wires 3 and the drain wire 6, while directing the metallic foil layer toward the interior side.

For the external conductor 7, braids formed by weaving fine conductive wires in a cylindrical shape may be used.

The drain wire 6 is configured to connect ground terminals at both the ends of the shielded electric wire 1. In the state that the drain wire 6 and the external conductor 7 are in stable contact with each other over the whole length of the shielded electric wire 1, both the ends of the drain wire 6 are grounded, such that good shielding characteristics are achieved.

Conventionally, in the shielded electric wire 1, it has been general that the drain wire 6 is twisted together with the insulation-coated electric wires 3a to 3d with a constant pitch, as shown in FIG. 3.

In FIG. 3, enlarged horizontal cross-sectional views A1, A2, and A3 show a positional relation between the drain wire 6 and the respective insulation-coated conductive wires 3a to 3d at positions p1, p2, and p3 dislocated longitudinally on the shielded electric wire 1.

However, in the shielded electric wire 1, the following problems (a) to (c) have occurred.

(a) A relative positional relation between the drain wire 6 and the respective insulation-coated conductive wires 3a to 3d is fixed. Closeness of the respective insulation-coated conductive wires 3a to 3d to the drain wire 6 is different (not equal). Accordingly, variation occurs in induction characteristics utilizing the respective insulation-coated conductive wires 3a to 3d and the drain wire 6.

(b) The relative positional relation between the drain wire 6 and the respective insulation-coated conductive wires 3a to 3d is fixed. An effect of twist to the drain wire 6 is not obtained. Accordingly, induction resistance characteristics utilizing the drain wire 6 are deteriorated.

(c) If a wire diameter of the drain wire 6 is small, the drain wire 6 is buried in a concave portion between the insulation-coated conductive wires 3a to 3d that run in parallel, thereby generating an area where the drain wire 6 and the external conductor 7 are not in contact with each other. As a result, there is a case where the shielding characteristics are deteriorated.

In order to avoid the problems, there has been proposed a shielded cable wherein a drain wire is wrapped, around outer circumference of a plurality of insulation-coated conductive wires, which are twisted with a constant twist pitch, with a different twist pitch from that of the insulation-coated conductive wires (refer to Patent Literature 1), or a shield twisted-pair cable wherein a plurality of drain wires are twisted in two respective concave portions formed on a twisted-pair cable made by twisting two insulation-coated conductive wires without being buried in the concave portions (refer to Patent Literature 2).

### Citation List

[Patent Literature 1] JP-A-2003-242840

[Patent Literature 2] JP-A-2008-287948

### SUMMARY OF INVENTION

### Technical Problem

The shielded electric wire disclosed in Patent Literature 1 is effective to solve the problems set forth in (a) to (c) above. However, in the step of providing the drain wire longitudinally on the outer circumference of the plurality of insulation-coated conductive wires, it is required to thoroughly manage the twist pitch of the drain wire to make the drain wire be accurately twisted on a bundle of the insulation-coated conductive wires with a different twist pitch from that of the respective insulation-coated conductive wires. Accordingly, there has been a new problem because the step for providing the drain wire longitudinally becomes complicated.

In case of the shielded electric wire disclosed in Patent Literature 2, the plurality of drain wires are arranged in the two respective concave portions between the insulation-coated conductive wires that run in parallel. Accordingly, a use amount of the drain wires increases, thereby increasing a weight of the shielded electric wire and costs. Since the number of core wires contained in one shielded electric wire is limited to two, if at least three core wires are required, it is necessary to use a bundle of a plurality of shielded twisted-pair cables. Accordingly, the shielded electric wire of Patent Literature 2 is not suitable for a shielded electric wire having a plurality of core wires.

The present invention has been made to solve the problems, and its object is to provide a shielded electric wire, in which variation rarely occurs in induction characteristics utilizing a drain wire of respective insulation-coated conductive wires, excellent induction-resistance characteristics are achieved by an effect of twist to the drain wire, a stable contact state between a shielding layer and the drain wire is assured even in case of reducing a wire diameter or a use amount of the drain wire, such that a weight and costs are reduced by reducing a use amount of the drain wire without deteriorating shielding characteristics, and a step of providing the drain wire longitudinally is simplified.

### Solution to Problem

The object of the present invention is accomplished by the configuration set forth below.

(1) A shielded electric wire comprising:

a plurality of insulation-coated conductive wires;

a drain wire provided along a length of the insulation-coated conductive wires and grounded at ends of the insulation-coated conductive wires;

an external conductor forming a shielding layer covering a periphery of the insulation-coated conductive wires and the drain wire; and

an insulation material layer covering an outer circumference of the external conductor,

wherein the drain wire is provided longitudinally and straight along one side of a conductive wire bundle of the plurality of twisted insulation-coated conductive wires.

(2) A shielded electric wire comprising:

a plurality of insulation-coated conductive wires;

a drain wire provided along a length of the insulation-coated conductive wires and grounded at ends of the insulation-coated conductive wires;

an external conductor forming a shielding layer covering a periphery of the insulation-coated conductive wires and the drain wire; and

an insulation material layer covering an outer circumference of the external conductor,

wherein the drain wire is wrapped, around an outer circumference of a conductive wire bundle of the plurality of insulation-coated conductive wires, in an opposite twist direction to a twist direction of the insulation-coated conductive wires.

According to the configuration (1), the relative positional relation between the respective insulation-coated conductive wires and the drain wire is in the state that closeness and spacing of the respective insulation-coated conductive wires to and from the drain wire is repeated per twist. Accordingly, closeness of the respective insulation-coated conductive wires to the drain wire is equalized. Therefore, variation rarely occurs in the induction characteristics utilizing the drain wire of the respective insulation-coated conductive wires.

The insulation-coated conductive wires have identical twist to the drain wire. Due to the effect of the twist to the drain wire, excellent induction-resistance characteristics are achieved.

The drain wire is provided longitudinally and straight along one side of a conductive wire bundle of the plurality of twisted insulation-coated conductive wires, and built in the form of lying over a concave portion between the insulation-coated conductive wires. Accordingly, even if the wire diameter of the drain wire is small, the drain wire is not buried in the concave portion between the insulation-coated conductive wires, so that the contact state between the drain wire and the external conductor over the whole length of the external conductor is desirably maintained.

Accordingly, even in case of reducing a use amount of the drain wire by reducing the wire diameter of the drain wire, the stable contact state between the external conductor and the drain wire is assured, so that a weight and costs are reduced by reducing a use amount of the drain wire without deteriorating the shielding characteristics.

Since the drain wire is merely provided longitudinally and straight along one side of the conductive wire bundle of the plurality of twisted insulation-coated conductive wires, all works for twisting the drain wire are unnecessary, so that the step of providing the drain wire longitudinally is simplified.

In case of the configuration (2) above, the relative positional relation between the respective insulation-coated conductive wires and the drain wire is in the state that all the insulation-coated conductive wires periodically vary in accordance with a twist phase of the insulation-coated conductive wires and a twist phase of the drain wire. In this case, closeness of the respective insulation-coated conductive wires to the drain wire is equalized. Therefore, variation rarely occurs in the induction characteristics utilizing the drain wire of the respective insulation-coated conductive wires.

Since the respective insulation-coated conductive wires have identical twist to the drain wire, excellent induction resistance characteristics due to the effect of the twist to the drain wire are achieved.

Since a twist direction of the drain wire is opposite to that of the respective insulation-coated conductive wires, the drain wire is built in the form of lying over the concave portion between the insulation-coated conductive wires, on the outer circumference of the conductive wire bundle of the plurality of twisted insulation-coated conductive wires. Accordingly, even if the wire diameter of the drain wire is small, the drain wire is not buried in the concave portion between the insulation-coated conductive wires, so that the contact state between the drain wire and the external conductor over the whole length of the external conductor is desirably maintained.

Accordingly, even in case of reducing a use amount of the drain wire by reducing the wire diameter of the drain wire, the stable contact state between the external conductor and the drain wire is assured, so that a weight and costs are reduced by reducing a use amount of the drain wire without deteriorating the shielding characteristics.

Since the twist direction of the drain wire is opposite to that of the respective insulation-coated conductive wires, a certain twist pitch for the drain wire can be set, regardless of the twist pitch of the insulation-coated conductive wires. Compared to the case where twist in the same direction as that of the insulation-coated conductive wires is applied while changing a pitch, the step of providing the drain wire longitudinally is simplified.

### BRIEF DESCRIPTION OF DRAWINGS

FIG. 1 is a perspective view of a penetration state of one embodiment of a shielded electric wire of the present invention, and horizontal cross-sectional views of positions dislocated longitudinally on the shielded electric wire of the embodiment.

FIG. 2 is a horizontal cross-sectional view of the shielded electric wire.

FIG. 3 is a perspective view of a conventional shielded electric wire and horizontal cross-sectional views of positions dislocated longitudinally on a conventional shielded electric wire.

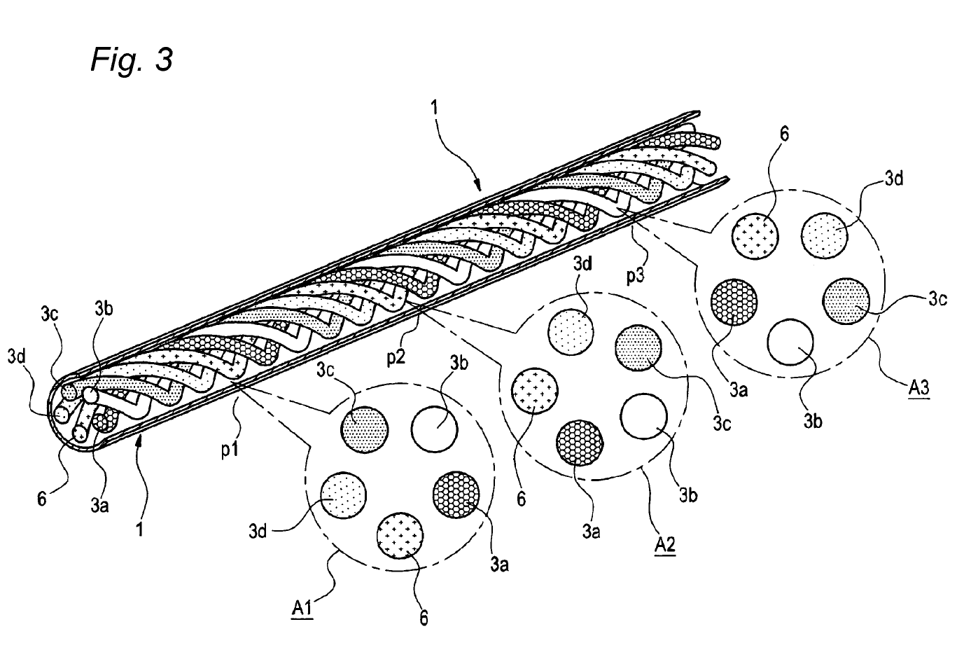

### DESCRIPTION OF EMBODIMENTS

Hereinafter, a preferable embodiment of the shielded electric wire of the present invention will be described with reference to the accompanying drawings.

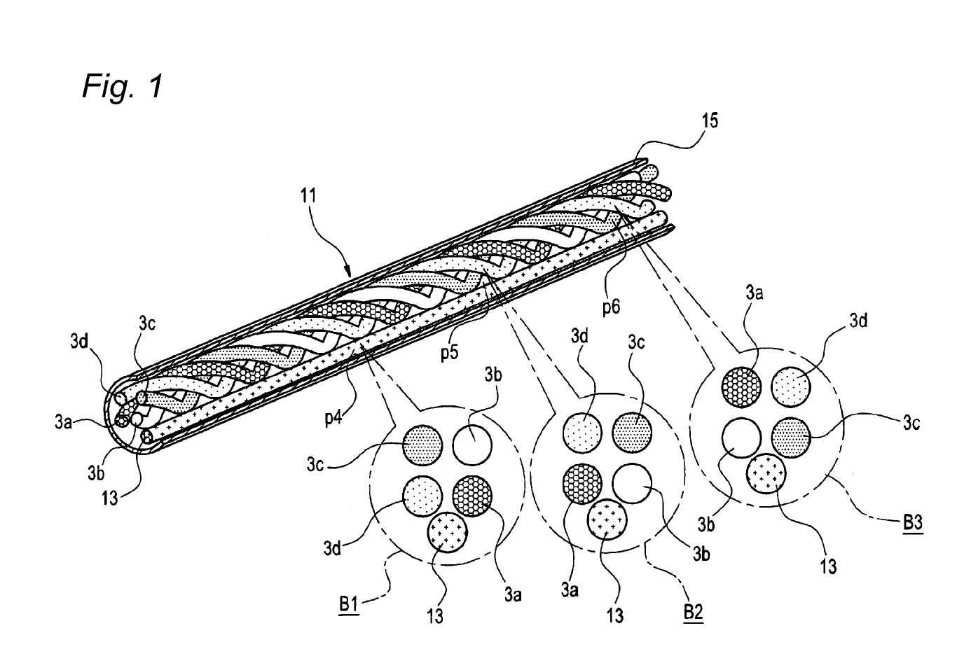

FIG. 1 shows one embodiment of the shielded electric wire of the present invention.

A shielded electric wire 11 shown in FIG. 1 is a shielded electric wire having four cores and includes four insulation-coated conductive wires 3a to 3d, a drain wire 13 provided along the length of the insulation-coated conductive wires 3a to 3d and grounded at the ends of the insulation-coated conductive wires 3a to 3d, an external conductor 15 forming a shielding layer covering the periphery of the insulation-coated conductive wires 3a to 3d and the drain wire 13, and an insulation material layer covering the outer circumference of the external conductor 15.

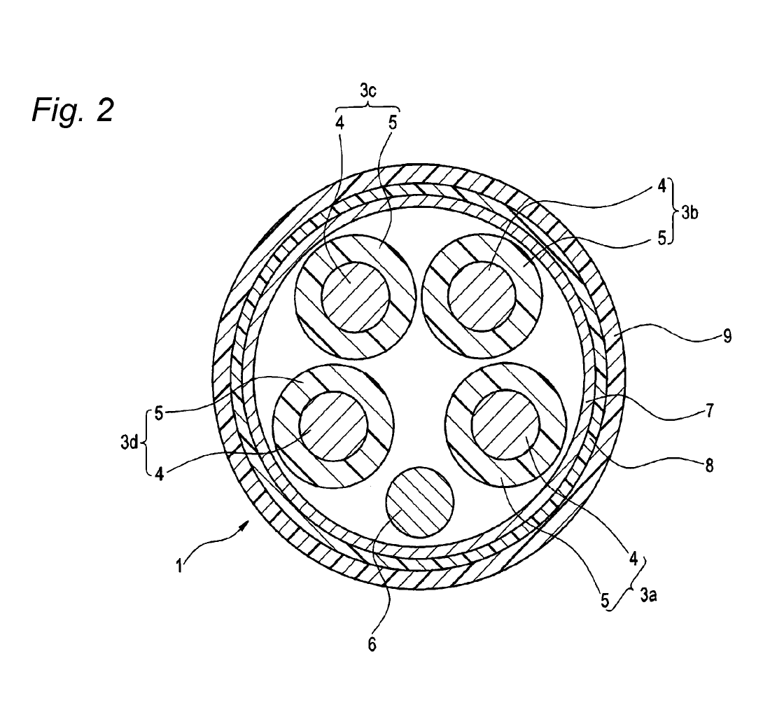

As shown in FIG. 2, the insulation-coated conductive wires 3a to 3d have the structure in which periphery of a conductor 4 used for transmission of a signal is covered with an insulation sheath 5, and the drain wire 13 is a naked conductor having no insulation sheath.

In this embodiment, the external conductor 15 is formed by laminating a metallic foil layer on one side surface of an insulation film and wrapped around the outer circumference of the four insulation-coated conductive wires 3 and the drain wire 13, while directing the metallic foil layer toward the interior side.

For the external conductor 15, braids made by weaving fine conductive wires in a cylindrical form may be used.

The drain wire 13 is configured to connect ground terminals at both the ends of the shielded electric wire 11. In the state that the drain wire 13 and the external conductor 15 are in stable contact with each other over the whole length of the external conductor 15, both the ends of the drain wire 13 are grounded, such that good shielding characteristics are achieved.

In this embodiment, the four insulation-coated conductive wires 3a to 3d are formed of one electric wire bundle made by twisting the four insulation-coated conductive wires 3a to 3d, which do not include the drain wire 13, with a predetermined twist pitch.

The drain wire 13 is provided longitudinally and straight along one side of the conductive wire bundle of the plurality of twisted insulation-coated conductive wires 3a to 3d.

In FIG. 1, the enlarged horizontal cross-sectional view B1, B2, and B3 show a positional relation between the drain wire 13 and the respective insulation-coated conductive wires 3a to 3d at positions p4, p5, and p6 dislocated longitudinally on the shielded electric wire 11.

In the shielded electric wire 11 of the embodiment that has been described, the relative positional relation between the respective insulation-coated conductive wires 3a to 3d and the drain wire 13 is in the state that closeness and spacing of the insulation-coated conductive wires 3a to 3d to and from the drain wire 13 are repeated per twist, so that closeness of the insulation-coated conductive wires 3a to 3d to the drain wire 13 is equalized. Therefore, variation rarely occurs in the induction characteristics utilizing the drain wire 13 of the respective insulation-coated conductive wires 3a to 3d, so that almost equal induction characteristics can be achieved with respect to all the insulation-coated conductive wires 3a to 3d.

Since the insulation-coated conductive wires 3a to 3d have identical twist to the drain wire 13, excellent induction resistance characteristics due to the effect of the twist to the drain wire 13 are achieved.

Since the drain wire 13 is provided longitudinally and straight along one side of the conductive wire bundle of the plurality of twisted insulation-coated conductive wires, the drain wire 13 is built in the form of lying over the concave portion between the insulation-coated conductive wires 3a to 3d. Accordingly, even if the wire diameter of the drain wire 13 is small, the drain wire 13 is not buried in the concave portion between the insulation-coated conductive wires 3a to 3d, and the contact state between the drain wire 13 and the external conductor 15 over the entire length of the external conductor is desirably maintained.

Accordingly, in case of reducing a use amount of the drain wire 13 by reducing the wire diameter of the drain wire 13, the stable contact state between the external conductor 15 and the drain wire 13 is assured, so that a weight and costs are reduced by reducing a use amount of the drain wire 13 without deteriorating the shielding characteristics.

Since the drain wire 13 is merely provided longitudinally and straight along one side of the conductive wire bundle of the plurality of twisted insulation-coated conductive wires, all works for twisting the drain wire 13 are unnecessary, so that the step of providing the drain wire 13 longitudinally is simplified.

In the shielded electric wire of the present invention, the drain wire may be wrapped in an opposite twist direction to a twist direction of the insulation-coated conductive wires, around the outer circumference of the conductive wire bundle of the plurality of insulation-coated conductive wires twisted with a predetermined twist pitch.

Likewise, in case of the shielded electric wire having the configuration, the same effect as those in the embodiment that has been described can be achieved.

In other words, in case of the shielded electric wire, in which the drain wire is wrapped in an opposite twist direction to a twist direction of the insulation-coated conductive wires, around the outer circumference of the conductive wire bundle of the plurality of the insulation-coated conductive wires, the relative positional relation between the respective insulation-coated conductive wires and the drain wire is in the state that all the insulation-coated conductive wires periodically vary in accordance with a twist phase of the insulation-coated conductive wires and a twist phase of the drain wire. In this case, closeness of the respective insulation-coated conductive wires to the drain wire is equalized. Therefore, variation rarely occurs in the induction characteristics utilizing the drain wire of the respective insulation-coated conductive wires, so that almost equal induction characteristics for all the insulation-coated conductive wires are achieved.

In case of the shielded electric wire, in which the drain wire is wrapped in an opposite twist direction to a twist direction of the insulation-coated conductive wires, around the outer circumference of the conductive wire bundle of the plurality of twisted insulation-coated conductive wires, the respective insulation-coated conductive wires have identical twist to the drain wire, so that excellent induction resistance characteristics due to the effect of the twist to the drain wire are achieved.

Even in the case where the twist direction of the drain wire is opposite to that of the respective insulation-coated conductive wires, the drain wire is built on the outer circumference of the conductive wire bundle in the form of lying over the concave portion between the insulation-coated conductive wires. Accordingly, even if the wire diameter of the drain wire is small, the drain wire is not buried in the concave portion between the insulation-coated conductive wires, so that the contact state between the drain wire and the external conductor over the entire length of the external conductor is desirably maintained.

Accordingly, even in case of reducing a use amount of the drain wire by reducing the wire diameter of the drain wire, the stable contact state between the external conductor and the drain wire is assured, so that a weight and costs are reduced by reducing a use amount of the drain wire without deteriorating the shielding characteristics.

In case of twisting the drain wire in an opposite twist direction to that of the insulation-coated conductive wires, on the outer circumference of the conductive wire bundle of the plurality of twisted insulation-coated conductive wires, a certain twist pitch for twisting the drain wire can be set, regardless of a twist pitch of the insulation-coated conductive wires. Accordingly, compared to the case where twist in the same direction as that of the insulation-coated conductive wires is applied while changing a pitch, the step of providing the drain wire longitudinally is simplified.

In the shielded electric wire of the present invention, the number of the insulation-coated conductive wires contained in the external conductor may be set to a numeral more than 2, and is suitable for a shielded electric wire having at least three cores.

The present invention is not limited to the embodiment that has been described, and may be properly modified or altered. In the embodiment that has been described, materials, shapes, dimensions, numerical values, forms, the number, arrangement positions, and others of the elements are not limited, and may be properly adopted if the objective of the present invention can be accomplished.

For example, the drain wire 13 may be wrapped in the same twist direction as that of the insulation-coated conductive wires 3a to 3d while changing a twist pitch, on the electric wire bundle of the plurality of twisted insulation-coated conductive wires 3a to 3d.

While the present invention has been described in detail or with reference to a specific embodiment, it is apparent to one skilled in the art that various modifications or corrections to the present invention may be added without departing from the spirit and the scope of the present invention.

The present application is based on the Japanese patent application (JP-A-2009-157871) filed on Jul. 2, 2009, the disclosures of which are herein incorporated by reference.

### INDUSTRIAL APPLICABILITY

According to the shielded electric wire of the present invention, closeness of the respective insulation-coated conductive wires to the drain wire is equalized. Therefore, variation rarely occurs in the induction characteristics utilizing the drain wire of the respective insulation-coated conductive wires. Since the insulation-coated conductive wires have identical twist to the drain wire, excellent induction resistance characteristics due to the effect of the twist to the drain wire are achieved.

The drain wire is buried in the form of lying over the concave portion between the insulation-coated conductive wires on the outer circumference of the conductive wire bundle of the plurality of insulation-coated conductive wires. Accordingly, even if the wire diameter of the drain wire is small, the drain wire is not buried in the concave portion between the insulation-coated conductive wires, so that the contact state between the drain wire and the external conductor over the whole length of the external conductor is desirably maintained. Accordingly, even in case of reducing a use amount of the drain wire by reducing the wire diameter of the drain wire, the stable contact state between the external conductor and the drain wire is assured, so that a weight and costs are reduced by reducing a use amount of the drain wire without deteriorating the shielded characteristics.

The drain wire is provided longitudinally and straight on the outer circumference of the conductive wire bundle of the plurality of twisted insulation-coated conductive wires, or twisted in the opposite direction. Accordingly, compared to the case where twist in the same direction as that of the insulation-coated conductive wires is applied while changing a pitch, the step of providing the drain wire longitudinally is simplified.

### REFERENCE SIGNS LIST

3a-3d insulation-coated conductive wires
4 conductor
5 insulation-coated conductive wires
9 insulation material layer
11 shielded electric wire
13 drain wire
15 external conductor
p4, p5, p6 cross-section positions

1. A shielded electric wire comprising:
a plurality of insulation-coated conductive wires;
a drain wire provided along a length of the insulation-coated conductive wires and grounded at ends of the insulation-coated conductive wires;
an external conductor forming a shielding layer covering a periphery of the insulation-coated conductive wires and the drain wire; and
an insulation material layer covering an outer circumference of the external conductor,
wherein the drain wire is provided longitudinally and straight along one side of a conductive wire bundle of the plurality of twisted insulation-coated conductive wires.

2. A shielded electric wire comprising:
a plurality of insulation-coated conductive wires;
a drain wire provided along a length of the insulation-coated conductive wires and grounded at ends of the insulation-coated conductive wires;
an external conductor forming a shielding layer covering a periphery of the insulation-coated conductive wires and the drain wire; and
an insulation material layer covering an outer circumference of the external conductor,
wherein the drain wire is wrapped, around an outer circumference of a conductive wire bundle of the plurality of insulation-coated conductive wires, in an opposite twist direction to a twist direction of the insulation-coated conductive wires.
